(19) United States
(12) Patent Application Publication
(10) Pub. No.: US 2016/0137506 A1
(43) Pub. Date: May 19, 2016

(54) GRAPHITIC NANOMATERIALS IN THE FORM OF CARBON ONIONS, PRODUCTION METHOD THEREOF AND USE OF SAME

(71) Applicant: COMIMSSSARIAT A L'ENERGIE ATOMIQUE ET AUX ENERGIES ALTERNATIVES, Paris (FR)

(72) Inventors: Jean-Charles ARNAULT, RAMBOUILLET (FR); Hugues GIRARD, VIROFLAY (FR); Tristan PETIT, BERLIN (DE)

(73) Assignee: Commissariat A L'Energie Atomique Et Aux Energies Alternatives, Paris (FR)

(21) Appl. No.: 14/897,480

(22) PCT Filed: Jun. 11, 2014
(86) PCT No.: PCT/FR2014/051421

§ 371 Date: Dec. 10, 2015

(30) Foreign Application Priority Data
Jun. 12, 2013 (FR) 13/55460

(51) Int. Cl. C01B 31/02

(52) U.S. Cl. CPC C01B 31/0293

(57) ABSTRACT

The present invention relates to graphite nanomaterials in the form of onion-like carbons, the method of preparation thereof and the use thereof.

The present invention relates to graphite nanomaterials in the form of onion-like carbons, the method of preparation thereof and use thereof.

Onion-like carbons (OLCs) (Butenko Y. V. et al., Phys. Rev. B 71 (2005) 075420) are very promising nanomaterials, in particular for the development of carbon supercapacitors with exceptional properties (Pech D. et al., Nature Nano, Vol. 5, September 2010).

The conventional method of synthesis for the OLCs consists of carrying out high-temperature annealing (1600-1800° C.) on detonation nanodiamonds (NDs) under high vacuum (10⁻⁶ mbar) for several hours (generally 2 h).

In fact, graphitization, which corresponds to the transformation of carbon diamond to graphite, requires the temperature to be raised above the graphitization temperature of diamond, i.e. 1600° C. In the approach of Kuznetsov V. L. et al. (J. Appl. Phys, Vol. 86(2), 1999)), this temperature is reached by radiative heat transfer by putting the NDs in a furnace, which consumes a lot of energy: the furnace enclosure and the crucible in which the nanodiamonds are placed being themselves heated to 1600° C., with considerable inertia. Moreover, in order to avoid oxidation of the NDs during this annealing, a high vacuum is required. Finally, in order to obtain good crystalline quality of the OLCs it is generally necessary to carry out annealing for several hours.

There is an alternative method consisting of irradiating the NDs with high-energy electrons (200 keV). However, this method is also very costly in energy terms and is not suitable for application on an industrial scale (Roddatis V. V. et al., Phys. Chem. Chem. Phys., 2002, 4, 1964-1967).

The use of microwaves has already been envisaged to reduce the structural defects of carbon nanotubes and thus improve their electronic properties (Imholt T. J et al., Chem. Mater. 2003, 15, 3969-3970; Lin W. ACS Nano, Vol. 4, No. 3, 1716-1722, 2010) but not for graphitizing diamond, i.e. transforming sp³-hybridized carbon (diamond) to sp²-hybridized carbon, in order to synthesize a new material of the onion-like carbon type.

One aspect of the present invention is to supply OLCs of very good crystalline quality, inexpensively, quickly and suitable for application on an industrial scale.

Another aspect of the invention is to provide a method for preparing OLCs.

Yet another aspect of the invention is to provide a method for preparing hydrophilic OLCs that can be deposited on surfaces.

The present invention relates to a method for preparing onion-like carbons, comprising a step of exposing spherical nanodiamonds having a size of the crystalline core comprised between approximately 2 nm and approximately 10 nm, as measured by X-ray diffraction (XRD), to microwaves for a sufficient time t to lead to an increase in heat at the surface of the nanodiamonds such as to induce complete graphitization of the crystalline core, under low vacuum at a pressure less than or equal to approximately 10⁻³ mbar. The inventors found, surprisingly, that exposing spherical nanodiamonds, having a size of the crystalline core comprised between approximately 2 nm and approximately 10 nm, to microwaves, allowed rapid production of OLCs at a lower cost than the techniques used conventionally in the prior art.

The term “OLCs” denotes nanomaterials constituted solely by concentric layers of graphitic carbon.

The nanodiamonds must be spherical so as to be able to obtain onion-like carbons.

By “spherical nanodiamonds” is meant nanodiamonds that can have crystal facets locally but the overall shape of which is inscribed in a sphere.

Therefore a non-spherical particle such as a diamond particle resulting from grinding will not form an onion-like carbon.

The nanodiamonds are constituted by a crystalline core containing between 70 and 90% of the total carbon atoms of the NDs, an intermediate layer of amorphous carbon with a thickness of 0.4 to 1.0 nm containing from 10 to 30% of the carbon atoms, and a surface layer containing various functional groups, essentially composed of carbon, oxygen, hydrogen and nitrogen.

The size of the crystalline core must be distinguished from the overall size of the NDs. In fact, “polycrystalline” particles can have an overall size of 5 nm for example, but will in reality be constituted by a cluster of nanometric crystalline cores, bound together by grain boundaries of amorphous carbon or sp²-hybridized carbon.

These clusters are unable to supply good starting material for making OLCs.

The core must therefore be monocrystalline and its size comprised between 2 and 10 nm.

Above a core size of 10 nm, it is difficult to obtain spherical nanodiamonds.

The proportion of nanodiamonds having a core size less than 2 nm is very small, which greatly limits the production of OLCs of this size.

The nanodiamonds are placed in an enclosure forming part of an installation comprising all the elements required for the preparation of OLCs.

The absorption of microwaves (MWs) by certain surface groups (sp² carbon, C—H end groups or CHₓ groups) of the NDs induces a very rapid local temperature increase, which leads to graphitization of the diamond core, i.e. to transformation of sp³-hybridized carbon to sp²-hybridized carbon.

Thus, when exposed to MWs, only the nanodiamonds are heated, thus eliminating the inertia of the enclosure and of the crucible in the enclosure when the NDs are placed in a crucible, as in the prior art.

Advantageously, the time t is from 1 second to 1 hour for completely converting the NDs to OLCs.

The expression “complete graphitization” means that the NDs are converted completely to OLCs, i.e. they only have a signature of sp² graphitic carbon and do not have a signature of sp³ diamond carbon in XRD, XPS or Raman spectroscopy. This corresponds to the presence of diffraction peaks characteristic of graphite in XRD as well as to characteristic lines in Raman spectroscopy spectroscopy (Mykhaylyk et al., J. Applied Physics 97 (2005) 074302). The sp²/sp³ carbon signatures with the aforementioned techniques are as follows:
Raman spectroscopy: presence of a diamond peak (between 1320 and 1332 cm⁻¹) and of two bands associated with sp² carbon: band D (between 1380 and 1400 cm⁻¹) and band G (between 1580 and 1620 cm⁻¹),
XRD: presence of a diffraction peak of diamond (111) 43.7°, and of a diffraction peak of graphite (002): 26.5°
XPS: The two hybridizations sp² and sp³ of carbon also correspond to different bond energies for the photoemission peak of carbon in XPS (Petit et al., Nanoscale, 2012, 4, 6792). The difference in bond energy between the sp² carbon of graphite and the sp³ carbon of diamond is comprised between 0.8 and 1 eV. The diamond component is positioned at +0.8-1 eV relative to that of the graphite.

The expression “under low vacuum at a pressure less than or equal to approximately 10⁻³ mbar” means that the pressure in the enclosure is comprised between approximately 10⁻⁴ mbar and approximately 10⁻³ mbar.

The use of low vacuum compared to high vacuum makes it possible to reduce the costs of preparation of the OLCs.

However, complete graphitization of the crystalline core of the NDs can also be carried out under high vacuum, i.e. below 10⁻⁴ mbar, in particular comprised between approximately 10⁻⁶ mbar and approximately 10⁻⁴ mbar and said high vacuum therefore forms part of the scope of the invention.

In an advantageous embodiment, the present invention relates to a method for preparing onion-like carbons, as defined above, in which said nanodiamonds are detonation nanodiamonds.

Detonation nanodiamonds are obtained by detonation of a material containing graphite and an explosive, or by the detonation of explosives exclusively (Dolmatov et al., Russian Chemical Review 76 (4) 339-360 (2007)).

In the latter case, advantageously a mixture of explosives composed of trinitrotoluene (TNT) and hexogen (RDX) is used.

In an advantageous embodiment, the present invention relates to a method for preparing onion-like carbons, as defined above, in which:
prior to exposure to microwaves, said nanodiamonds have sp²-hybridized carbon atoms at their surface, or are substantially devoid of sp²-hybridized carbon atoms at their surface and are subjected to partial surface graphitization, in particular by annealing under high vacuum, prior to exposure to microwaves, in order to obtain nanodiamonds that are partially graphitized at the surface, or
prior to exposure to microwaves, said nanodiamonds have carbon-hydrogen bonds at their surface, or are substantially devoid of carbon-hydrogen bonds at their surface and have heteroelements such as oxygen, nitrogen or fluorine, and in particular more than 2 at. % of oxygen at said surface, and are subjected to partial surface hydrogenation, in order to obtain nanodiamonds that are partially hydrogenated at the surface.

The expression “the nanodiamonds have, prior to exposure to microwaves, sp²-hybridized carbon atoms at their surface” means that the NDs have sp²-hybridized carbons at their surface, as determined by the simultaneous presence of a graphite signature and a diamond signature in XRD, XPS or Raman spectroscopy and correspond to nanodiamonds partially graphitized at the surface.

In this case, the NDs are used directly for the aforementioned microwave treatment for forming OLCs, without prior treatment of the NDs.

The expression “substantially devoid of sp²-hybridized carbon atoms at their surface” means that the NDs are substantially devoid of sp²-hybridized carbon at their surface, as determined by the substantial absence of a graphite signature in XRD, XPS or Raman spectroscopy, i.e. the NDs are completely devoid of sp²-hybridized carbon at their surface and correspond to nanodiamonds that are not at all graphitized or the NDs are insufficiently provided with sp²-hybridized carbon at their surface, as determined by the lack of a graphite signature in XRD, XPS or Raman spectroscopy, i.e. the NDs are insufficiently provided with sp²-hybridized carbon at their surface and correspond to insufficiently graphitized nanodiamonds.

The expression “insufficiently graphitized nanodiamonds” refers to the limit of detection of graphite at the surface of nanodiamonds, namely 0.5 at. % with the XPS method.

In these last two cases, the NDs must therefore undergo a treatment of partial surface graphitization, in particular by annealing under high vacuum, prior to exposure to microwaves, in order to obtain nanodiamonds that are partially graphitized at the surface, i.e. having both a graphite signature and a diamond signature in XRD, XPS or Raman spectroscopy.

The treatments of partial surface graphitization are well known to a person skilled in the art and are in particular carried out by annealing under high vacuum, i.e. by heating at a temperature from approximately 700 to approximately 1100° C. for 1 h to 3 h under a vacuum comprised between approximately 10⁻⁶ mbar and approximately 10⁻⁴ mbar (Petit et al., Physical Review B 84 (2011) 233407; Petit et al., Nanoscale 4 (2012) 6792). The expression “prior to exposure to microwaves, said nanodiamonds have carbon-hydrogen bonds at their surface” means that the NDs are partially hydrogenated at the surface.

In this case, the NDs are used directly for the aforementioned microwave treatment for forming OLCs, without prior treatment of the NDs.

The expression “substantially devoid of carbon-hydrogen bonds at their surface and have heteroelements such as oxygen, nitrogen or fluorine, and in particular more than 2 at. % of oxygen at said surface” means that:
the NDs are completely devoid of carbon-hydrogen bonds at their surface and the presence of heteroelements, such as oxidized groups bound covalently to the surface, corresponds to nanodiamonds that are not hydrogenated at all, or that:
the NDs are insufficiently hydrogenated at their surface and the presence of heteroelements, in particular oxidized groups bound covalently to the surface, corresponds to insufficiently hydrogenated nanodiamonds.

In these last two cases, the NDs must therefore undergo a treatment of partial surface hydrogenation, in particular by treatment carried out with microwave plasma in order to obtain nanodiamonds that are partially hydrogenated at the surface.

Hydrogenation makes it possible to desorb the oxidized end groups and saturate the pendant bonds with hydrogen atoms, while preferentially etching the amorphous carbon and the sp²-hybridized carbon in parallel.

In fact, etching of sp² carbon is particularly rapid under atomic hydrogen. For efficient etching of the graphitic and amorphous structures, the surface has to be exposed to atomic hydrogen. This atomic hydrogen can be generated by dissociation of dihydrogen molecules using a hot filament or the electric field associated with radio waves or microwaves.

In an advantageous embodiment, the present invention relates to a method for preparing onion-like carbons, as defined above, in which said nanodiamonds have an overall size comprised between approximately 2 nm and approximately 15 nm, in particular from approximately 4 nm to approximately 10 nm.

At 2 nm, the nanodiamond is only equivalent to the crystalline core. Above 2 nm, it is either equivalent to the crystalline core or it can be covered with the other intermediate and surface layers mentioned above.

In an advantageous embodiment, the present invention relates to a method for preparing onion-like carbons, as defined above, in which said nanodiamonds can comprise impurities, in particular nitrogen, in particular in an atomic proportion less than 3 at. %.

It should be noted that the oxygen and hydrogen atoms are mainly present at the surface, whereas the nitrogen atoms, in particular originating from the explosives used for synthesis by detonation, are distributed homogeneously in the core and the two aforementioned layers surrounding it (the intermediate layer and the surface layer).

In an advantageous embodiment, the present invention relates to a method for preparing onion-like carbons, as defined above, in which the low vacuum in the enclosure in which the nanodiamonds are exposed to the microwaves corresponds to a pressure comprised between approximately 10⁻⁴ mbar and 10⁻³ mbar, in particular equal to approximately 10⁻³ mbar.

The enclosure in which the NDs are exposed to the microwaves is more particularly constituted by a quartz tube, which avoids the use of a furnace and a crucible, thus eliminating the inertia of the enclosure (furnace) and of the crucible.

Below 10⁻⁴ mbar, the reaction is still possible, but it becomes more expensive and more difficult to use industrially.

Above 10⁻³ mbar, the vacuum is not sufficient to guarantee an atmosphere devoid of gases that absorb the microwaves produced, thus leading to the formation of a plasma and preventing the formation of OLCs.

FIG. 1 shows an example of an installation constituted in particular by a quartz enclosure and making it possible to carry out, among other things, preparation of the OLCs.

In an advantageous embodiment, the present invention relates to a method for preparing onion-like carbons, as defined above, in which said nanodiamonds:
are partially graphitized at the surface, or
are substantially devoid of sp²-hybridized carbon atoms at their surface and are subjected, prior to exposure to microwaves, to partial surface graphitization.
   In this embodiment, the NDs used are:
either partially graphitized at the surface and therefore have sp²-hybridized carbons at their surface, as determined by the simultaneous presence of a graphite signature and a diamond signature in XRD, XPS or Raman spectroscopy and therefore do not require graphitization prior to the microwave treatment;
or substantially devoid of sp²-hybridized carbon atoms at their surface, as determined by the presence of a diamond signature and the substantial absence of a graphite signature in XRD, XPS or Raman spectroscopy and therefore require partial surface graphitization.

In an advantageous embodiment, the present invention relates to a method for preparing onion-like carbons, as defined above, comprising the following steps:
a. Under low vacuum, pumping an enclosure, in particular constituted by a quartz tube, into which nanodiamonds partially graphitized at the surface have been introduced, in order to obtain a pressure comprised between approximately 10⁻⁴ mbar and 10⁻³ mbar, in particular a pressure of approximately 10⁻³ mbar;
b. Exposing said enclosure containing the nanodiamonds partially graphitized at the surface, under low vacuum obtained in the preceding step, to microwaves the power of which is comprised between approximately 50 watts and approximately 2000 watts, the power being in particular approximately 300 watts, for a time t comprised between approximately 1 second and approximately 1 hour, in particular approximately 30 minutes, in order to induce complete graphitization of the crystalline core of the nanodiamonds and obtain onion-like carbons.

In this embodiment, the NDs used have sp²-hybridized carbons at their surface and therefore do not require graphitization prior to the microwave treatment.

Advantageously, the time t is comprised between 10 and 60 minutes, in particular from 20 to 40 minutes, more particularly from 25 to 35 minutes, and in particular the time t is 25, 26, 27, 28, 29, 30, 31, 32, 33, 34 or 35 minutes, in particular 30 minutes for completely converting the NDs to OLCs.

The exposure time depends on the power of the microwaves.

As an example, for a maximum power of 300 watts, the exposure time of partially graphitized nanodiamonds is 30 minutes.

In an advantageous embodiment, the present invention relates to a method for preparing onion-like carbons, as defined above, further comprising, before the step of pumping under low vacuum, a step of partial surface graphitization of nanodiamonds that are substantially devoid of sp²-hybridized carbon atoms at their surface, said graphitization in particular being carried out by annealing under high vacuum, in order to produce nanodiamonds that are partially graphitized at the surface.

In this embodiment the NDs are substantially devoid of sp²-hybridized carbon atoms at their surface and therefore require partial graphitization prior to exposure to microwaves, because an ungraphitized ND does not react with microwaves under vacuum.

The partial graphitization can be carried out by any technique well known to a person skilled in the art and in particular the surface of the NDs can be partially transformed to graphitic carbon by annealing at high temperature under vacuum or under inert atmosphere at temperatures comprised between approximately 700 and approximately 1100° C. for 1 h to 3 h under a vacuum comprised between approximately 10⁻⁶ mbar and approximately 10⁻⁴ mbar.

Annealing under vacuum at temperatures above 1400° C. leads to the formation of graphitic onions, as described in the prior art, which cannot be used for preparing OLCs.

In an advantageous embodiment, the present invention relates to a method for preparing onion-like carbons, as defined above, in which said nanodiamonds, prior to exposure to microwaves:
have carbon-hydrogen bonds at their surface, or
are substantially devoid of carbon-hydrogen bonds at their surface and have heteroelements such as oxygen, nitrogen or fluorine, and in particular more than 2 at. % of oxygen at said surface, and are subjected to partial surface hydrogenation, in order to obtain nanodiamonds that are partially hydrogenated at the surface, or
are insufficiently hydrogenated at their surface and have heteroelements such as oxygen, nitrogen or fluorine, and in particular more than 2 at. % of oxygen at said surface, and are subjected to partial surface hydrogenation in order to obtain nanodiamonds that are partially hydrogenated at the surface.

In this embodiment, the NDs used:
have carbon-hydrogen bonds at their surface and therefore do not require hydrogenation prior to the microwave treatment; or
are substantially devoid of carbon-hydrogen bonds at their surface and have heteroelements such as oxygen, nitrogen or fluorine, and in particular more than 2 at. % of oxygen at said surface, and therefore require hydrogenation so as to obtain carbon-hydrogen bonds at their surface, as an ND that has not been hydrogenated does not react with microwaves under vacuum, or
are insufficiently hydrogenated at their surface and have heteroelements such as oxygen, nitrogen or fluorine, and in particular more than 2 at. % of oxygen at said surface, and therefore require hydrogenation so as to obtain carbon-hydrogen bonds at their surface, as an ND that has not been hydrogenated does not react with microwaves under vacuum.

In an advantageous embodiment, the present invention relates to a method for preparing onion-like carbons, as defined above, comprising the following steps:
a. Under low vacuum, pumping an enclosure, into which nanodiamonds partially hydrogenated at the surface have been introduced, in order to obtain a pressure comprised between approximately 10⁻⁴ mbar and 10⁻³ mbar, in particular a pressure of approximately 10⁻³ mbar;
b. Exposing said enclosure containing the nanodiamonds partially hydrogenated at the surface, under low vacuum obtained in the preceding step, to microwaves the power of which is comprised between approximately 50 watts and approximately 2000 watts, the power being in particular approximately 300 watts, for a time t comprised between approximately 1 second and approximately 1 minute, in particular 30 seconds, in order to induce complete graphitization of the crystalline core of the nanodiamonds and obtain onion-like carbons.

In this embodiment, the NDs used have carbon-hydrogen bonds at their surface and therefore do not require hydrogenation prior to the microwave treatment.

Advantageously, the time t is comprised between 1 and 30 seconds, in particular from 10 to 30 seconds, in particular from 25 to 35 seconds, in particular 25, 26, 27, 28, 29, 30, 31, 32, 33, 34 or 35 seconds, in particular 30 seconds for completely converting the NDs to OLCs.

The exposure time depends on the power of the microwaves.

As an example, for a maximum power of 300 watts, the time of exposure of partially hydrogenated nanodiamonds is 30 seconds.

In an advantageous embodiment, the present invention relates to a method for preparing onion-like carbons, as defined above, further comprising, before the step of pumping under low vacuum, a step of hydrogenation of nanodiamonds that are substantially devoid of carbon-hydrogen bonds at their surface and have heteroelements such as oxygen, nitrogen or fluorine, and in particular more than 2 at. % of oxygen at said surface, said hydrogenation in particular being carried out by microwave plasma, under a pressure of 14-15 mbar at a power from 50 W to approximately 2000 W, in particular 300 W, for 5 minutes to approximately 30 minutes, in particular 15 minutes, in order to produce nanodiamonds that are partially hydrogenated at the surface.

In an advantageous embodiment, the present invention relates to a method for preparing onion-like carbons, as defined above, further comprising, before the step of pumping under low vacuum, a step of hydrogenation of nanodiamonds that are substantially devoid of carbon-hydrogen bonds at their surface and have heteroelements such as oxygen, nitrogen or fluorine, and in particular more than 2 at. % of oxygen at said surface, said hydrogenation being carried out in the same installation, constituted in particular by a quartz enclosure, as that used for said exposure to microwaves.

In this embodiment, hydrogenation, pumping said enclosure under low vacuum and exposing said enclosure containing the nanodiamonds partially hydrogenated at the surface, under low vacuum, to microwaves, are carried out in situ in the same installation in particular constituted by a quartz enclosure and making it possible to prepare OLCs.

This embodiment comprising a hydrogenation step is therefore implemented more easily than the embodiment requiring a preliminary graphitization step as the latter cannot be carried out in the same installation as that used for exposing partially graphitized NDs to microwaves.

In an advantageous embodiment, the present invention relates to a method for preparing onion-like carbons, as defined above, in which a means for controlling the power absorbed is connected to the enclosure defined above, in particular to the quartz tube.

In this embodiment, the NDs used:
either have sp²-hybridized carbons at their surface and therefore do not require graphitization prior to the microwave treatment; or
are substantially devoid of sp²-hybridized carbon atoms at their surface, as determined by the presence of a diamond signature and the substantial absence of a graphite signature in XRD, XPS or Raman spectroscopy and therefore require partial surface graphitization, or
have carbon-hydrogen bonds at their surface and therefore do not require hydrogenation prior to the microwave treatment; or
are substantially devoid of carbon-hydrogen bonds at their surface and have heteroelements such as oxygen, nitrogen or fluorine, and in particular more than 2 at. % of oxygen at said surface, and therefore require hydrogenation so as to obtain carbon-hydrogen bonds at their surface, as an ND that has not been hydrogenated does not react with microwaves under vacuum.

Said control means can for example be a control piston making it possible, as a function of its forward or backward movement, to adjust the focusing of the microwaves on the NDs and thus vary the power absorbed by said nanodiamonds, whether they are graphitized or hydrogenated, as well as the power reflected by the enclosure.

The greater the power absorbed by the NDs and the lower the power reflected by the enclosure, the faster the exposure to microwaves will be, and therefore the faster the production of OLCs will be, thus reducing the preparation costs.

In an advantageous embodiment, the power absorbed by the NDs is at least 80% and the power reflected by the enclosure is less than or equal to 20%, advantageously the power absorbed by the NDs is at least 90% and the power reflected by the enclosure is less than or equal to 10%.

In an advantageous embodiment, the present invention relates to a method for preparing onion-like carbons, as defined above, in which a means for controlling the power absorbed is connected to the enclosure, in particular to the quartz tube, and in which the power absorbed by said nanodiamonds is substantially equal to 100% and the power reflected is substantially equal to 0%.

The expression “substantially equal to 100%” means that the power absorbed by the NDs is greater than or equal to 99%.

The expression “substantially equal to 0%” means that the power reflected by the enclosure is less than or equal to 1%.

Advantageously, the power absorbed by the NDs is equal to 100% and the power reflected by the enclosure is equal to 0%.

In an advantageous embodiment, the present invention relates to a method for preparing onion-like carbons, as defined above, in which the temperature increase in said enclosure under low vacuum containing partially graphitized nanodiamonds, or partially hydrogenated nanodiamonds, during exposure to microwaves for said time t, causes scintillation or emission of white light from said partially graphitized nanodiamonds, or from said partially hydrogenated nanodiamonds.

Absorption of MWs by certain surface groups (sp² carbon, C—H end groups or CHₓ groups) of the NDs induces a very rapid local temperature increase, which makes it possible to reach a critical temperature that leads to scintillation or to emission of light from the NDs (which may correspond to the formation of electric arcs), in order to form OLCs. The scintillation or luminous emission observed leads to graphitization of the diamond core, i.e. transformation of sp³-hybridized carbon to sp²-hybridized carbon.

In the case where there is no scintillation or luminous emission, there is no formation of OLCs.

In an advantageous embodiment, the present invention relates to a method for preparing onion-like carbons, as defined above, in which the temperature increase in said enclosure under low vacuum containing partially graphitized nanodiamonds, or partially hydrogenated nanodiamonds, during exposure to microwaves for said time t, causes scintillation or emission of white light from said partially graphitized nanodiamonds, or from said partially hydrogenated nanodiamonds, and in which said temperature is approximately 1000° C.

In an advantageous embodiment, the present invention relates to a method for preparing onion-like carbons, as defined above, in which said onion-like carbons, obtained after exposure to microwaves, are exposed to UV (typically λ (wavelength)<380 nm) under an oxygen atmosphere in order to make the aforesaid onion-like carbons hydrophilic, i.e. having the possibility of being stabilized in water.

In order to be able to deposit the OLCs on large areas, for example for making supercapacitors, it is advantageous to obtain OLCs in the form of a stable suspension in a solvent (which can be water).

The OLCs are initially hydrophobic, but UV treatment under an oxygen atmosphere, i.e. an oxidation treatment, makes it possible to stabilize them in water in order to prepare a stable suspension of OLCs in water after sonication.

The use of UV treatment can make the OLCs hydrophilic, without significantly altering their crystalline quality.

UV exposure can be carried out at various wavelengths, typically between 150 and 380 nm.

The expression “oxygen atmosphere” means both pure oxygen and a mixture of oxygen and one or more other gases that are inert for the OLCs, such as for example nitrogen, argon etc., the proportion of pure oxygen by weight relative to the aforesaid other gas varying from 100% to approximately 20%.

In this embodiment, UV exposure is carried out after isolating the OLCs obtained by the method of the invention or directly after obtaining the latter, with the same installation.

An atmosphere of pure oxygen can advantageously be used in order to increase the rate of oxidation.

UV exposure can also be carried out starting from OLCs obtained by a method other than that of the invention.

In an advantageous embodiment, the present invention relates to a method for preparing onion-like carbons, as defined above, in which said onion-like carbons, obtained after exposure to microwaves, are exposed to UV under an oxygen atmosphere in order to make the aforesaid onion-like carbons hydrophilic, in which UV exposure is carried out in air.

Oxidation of the OLCs in air makes it possible to reduce the costs of preparation relative to oxidation under pure oxygen.

In an advantageous embodiment, the present invention relates to a method for preparing onion-like carbons, as defined above, in which said onion-like carbons, obtained after exposure to microwaves, are exposed to UV under an oxygen atmosphere in order to make the aforesaid onion-like carbons hydrophilic, in which the UV wavelength is approximately 172 nm.

The wavelength described above can be obtained for example by means of a Heraeus excimer lamp (Heraeus Noblelight).

In an advantageous embodiment, the present invention relates to a method for preparing onion-like carbons, as defined above, in which said onion-like carbons, obtained after exposure to microwaves, are exposed to UV under an oxygen atmosphere in order to make the aforesaid onion-like carbons hydrophilic, in which the air pressure before UV exposure is adjusted to approximately 200 mbar.

Exposure takes place in a confined place, in particular in a quartz tube, which is placed under partial vacuum or pumped to 200 mbar before exposure, in order to limit UV absorption by the molecules present in the air.

The confined place can be the same enclosure as defined above or another closed vessel.

Advantageously, the distance between the NDs deposited in the tube, in particular in a crucible, and the UV lamp is less than 10 cm, in particular less than 5 cm.

In an advantageous embodiment, the present invention relates to a method for preparing onion-like carbons, as defined above, in which said onion-like carbons, obtained after exposure to microwaves, are exposed to UV under an oxygen atmosphere in order to make the aforesaid onion-like carbons hydrophilic, in which the UV exposure time is comprised between 1 minute and 4 hours, in particular 2 h.

In an advantageous embodiment, the present invention relates to a method for preparing onion-like carbons, as defined above, in which said onion-like carbons, obtained after exposure to microwaves, are exposed to UV under an oxygen atmosphere in order to make the aforesaid onion-like carbons hydrophilic, in which exposure to the microwaves and exposure to UV are carried out in the same enclosure, in particular constituted by a quartz tube.

Another advantage of the invention is that it is possible to use the same installation constituted by the same enclosure for the step of preparing the OLCs starting from the NDs and the step of oxidation of the OLCs formed, and to carry out both steps in situ.

In an advantageous embodiment, the present invention relates to a method for preparing onion-like carbons, as defined above, in which said onion-like carbons, obtained after exposure to microwaves, are exposed to UV under an oxygen atmosphere in order to make the aforesaid onion-like carbons hydrophilic, in which hydrogenation, exposure to microwaves and exposure to UV re carried out in the same enclosure, in particular constituted by a quartz tube.

Yet another advantage of the invention is that it is possible to use the same installation constituted by the same enclosure for the hydrogenation step, the step of preparing the OLCs starting from the NDs and the step of oxidation of the OLCs formed, and to carry out said three steps in situ.

According to another aspect, the invention relates to a product as obtained by one of the methods defined above, in which the OLCs are not subjected to oxidation after they are prepared.

According to another aspect, the invention relates to a product as obtained by one of the methods defined above, in which the OLCs are then subjected to oxidation after their preparation.

According to another aspect, the present invention relates to the use of a product as obtained by one of the methods defined above, in which the OLCs are not subjected to oxidation after their preparation, or to one of the methods defined above, in which the OLCs are then subjected to oxidation after their preparation, in which said product is suspended in water, in particular at a concentration of at most 20 mg/ml, in particular 5 mg/ml, for deposition on surfaces, in particular for preparing supercapacitors.

Deposition on surfaces is well known to a person skilled in the art (for example deposition by dipping, by spraying or by spin-coating).

Above 20 mg/ml, the concentration of OLCs is too great for correct suspension.

In an advantageous embodiment, the present invention relates to the use of a product as obtained by one of the methods defined above, in which the OLCs are not subjected to oxidation after their preparation, or one of the methods defined above, in which the OLCs are then subjected to oxidation after their preparation, for protection against electromagnetic waves.

Onion-like carbons are carbon nanomaterials that have multiple applications.

They can in particular be used for developing supercapacitors, for absorbing electromagnetic waves, for inducing UV radiation filtration properties or for improving the friction performance of lubricants.

OLCs can accumulate energy in the form of opposite charges in a confined space, according to the principle of capacitors. However, the quantity of energy stored is much greater than with a conventional capacitor. The advantage relative to a conventional battery is that it is possible to charge and discharge supercapacitors particularly quickly. These supercapacitors are therefore intermediate between capacitors and batteries. The quite particular onion structure of nanometric size of the OLCs makes it possible to manufacture extremely compact supercapacitors having exceptional charge and discharge capacities (Pech et al., 2010). These supercapacitors could be particularly useful in applications for which it is useful to store energy in a reduced volume such as in mobile electronics, biomedical implants or microsensors.

OLCs can also be used for synthesis of materials that absorb electromagnetic waves in the microwave range (1-300 GHz) (Maksimenko et al., 2007) and THz range (Liu, Das, & Megaridis, 2014). Attenuation of electromagnetic waves is important in the field of reduction of the radar signature of flying objects, for protecting users of high-power lasers or for reducing electromagnetic noise for electronic modules or computers, for example. The benefit of OLCs is that they combine good absorption capacities with light weight. They can easily be incorporated in portable objects and can be synthesized at low cost. It has also recently been proposed to use OLCs as carbon antennas, to replace the conventional antennas made of metallic materials (Vacirca, McDonough, Jost, Gogotsi, & Kurzweg, 2013).

The use of OLCs has also been mentioned in the field of lubricants. A very significant reduction of the coefficient of friction (50%) has been measured when OLCs are added to engine oils (Street, K. W., Marchetti M., Vander Wal R. L., Tomasek A. J., 2004) (Matsumoto N., Joly-Pottuz L., Kinoshita H., Ohmae N., 2007).

In the particular case where formation of the onion-like carbon is incomplete and a diamond core remains, it can be used as a filtering agent for UV radiation (UVA, UVB and UVC), in particular for the field of cosmetics and sun creams. The compromise between the UV filtering capacity and transparency of the cream is linked to the proportion of graphite layers on the nanodiamond.

### DESCRIPTION OF THE FIGURES

FIGS. 1A to 1C show the installation that can be used both for hydrogenation of the NDs and for preparation of the OLCs or oxidation of the OLCs.

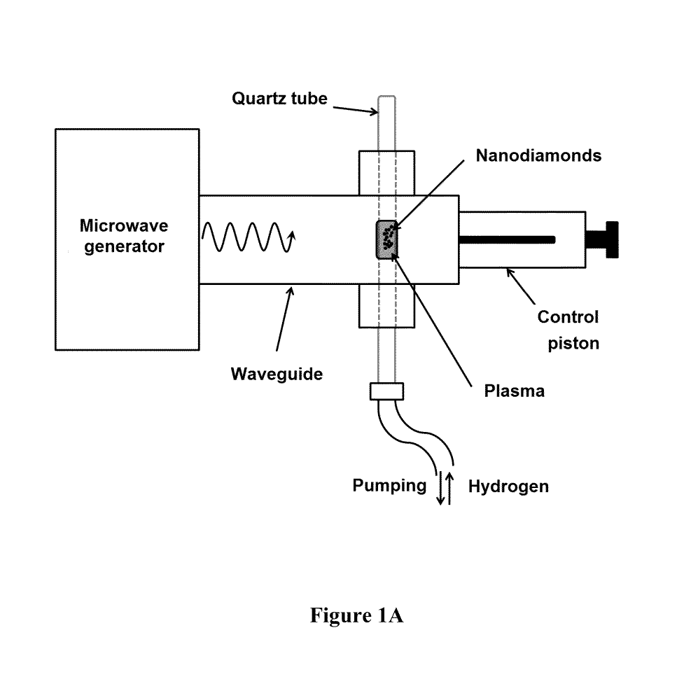

FIG. 1A: installation for hydrogenation.

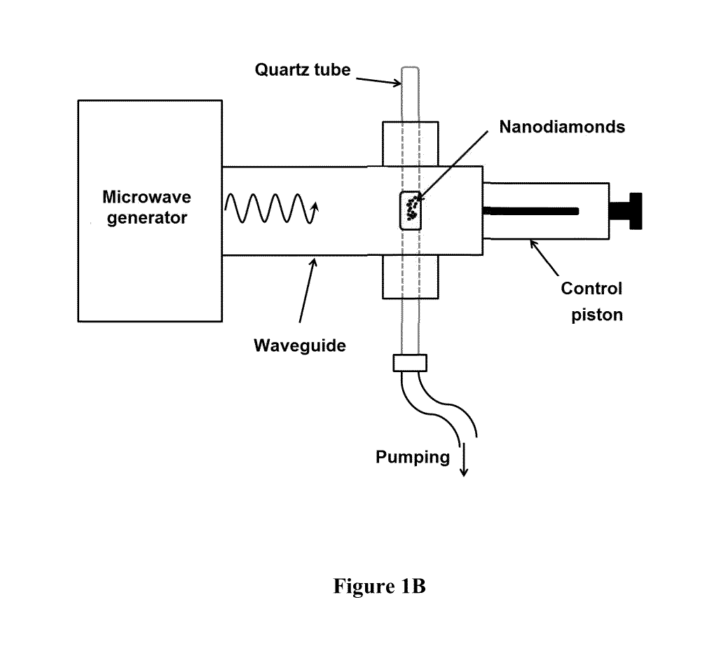

The installation comprises the microwave generator, quartz tube, waveguide, control piston, pumping system, hydrogen inlet and the plasma with the nanodiamonds.

FIG. 1B: Preparation of the OLCs.

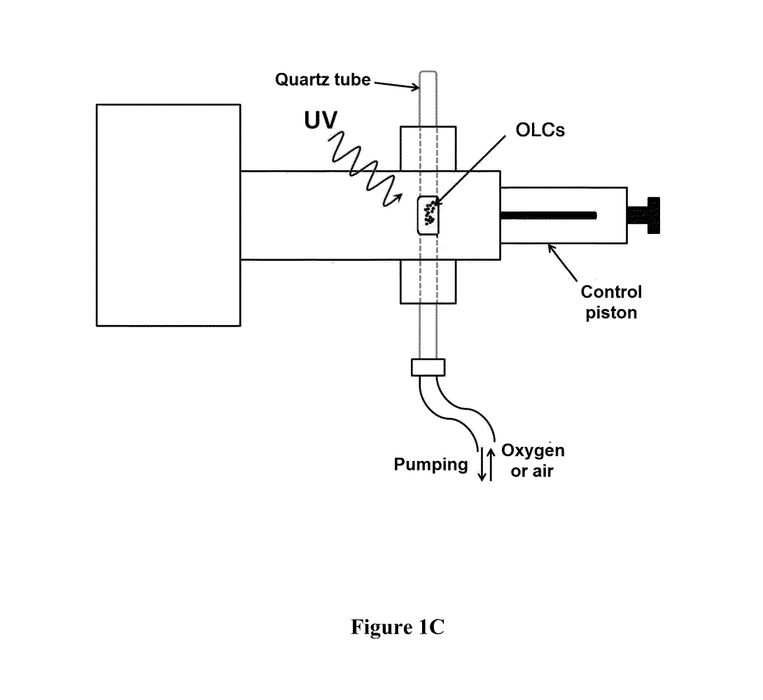

The installation comprises the microwave generator, quartz tube, waveguide, control piston, pumping system and the enclosure containing the nanodiamonds.

FIG. 1C: Oxidation of the OLCs

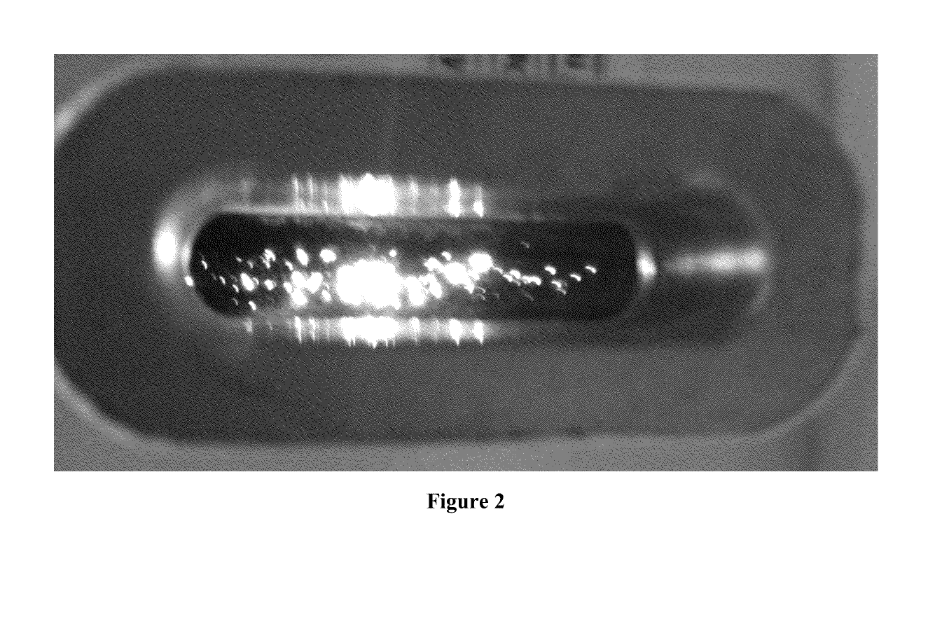

The installation comprises the quartz tube, pumping system, oxygen or air inlet, and UV directed on the enclosure containing the OLCs prepared from the NDs.

FIG. 2 shows the generation of white light during exposure of the NDs to MWs (300 W, 30 seconds, 10⁻³ mbar).

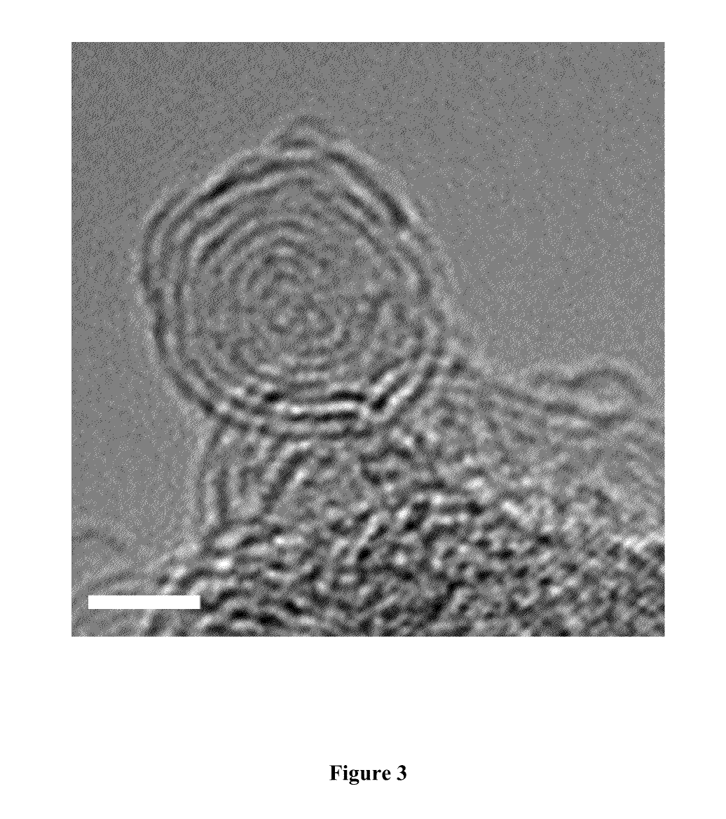

FIG. 3 shows the HRTEM image of an OLC synthesized by microwave exposure of hydrogenated detonation NDs according to Example 1, revealing the graphite layers and disappearance of the diamond core.

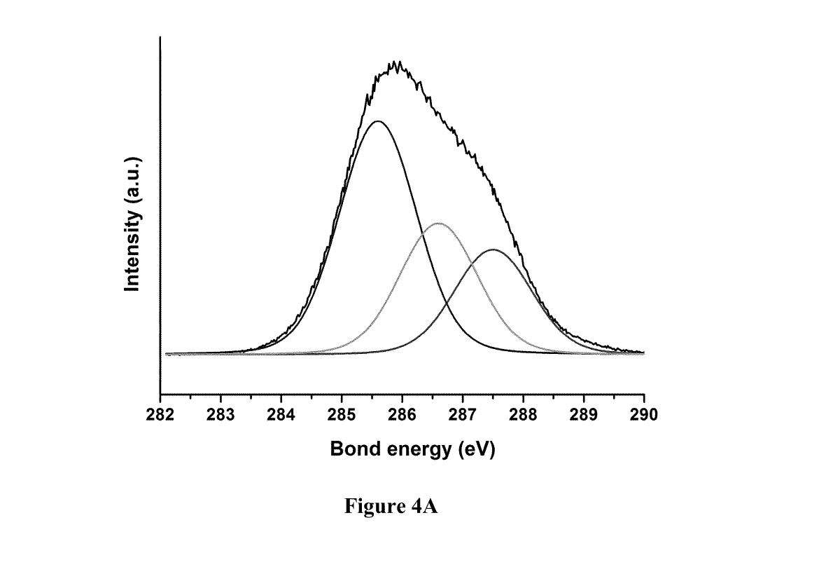

The scale bar is 2 nm.

FIGS. 4A and 4B show the XPS C1s spectra of the NDs after hydrogenation (FIG. 4A) and after microwave graphitization (FIG. 4B) according to Example 1.

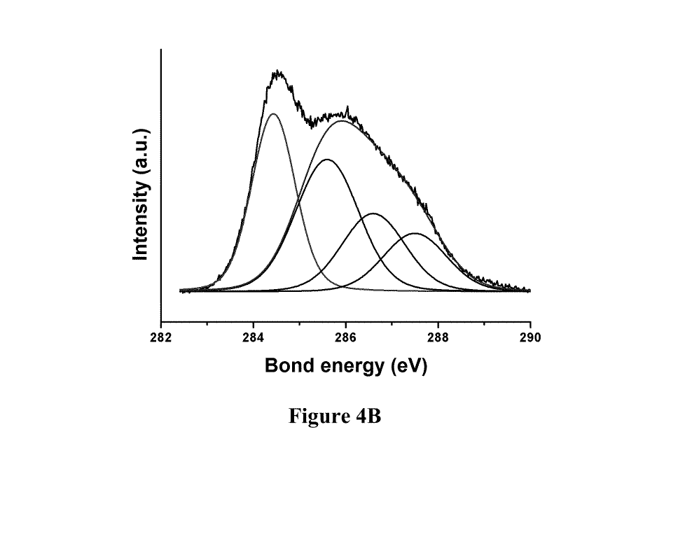

The appearance of an sp² peak with low bond energy is clearly visible (component located at 284.5 eV).

X-axis: Bond energy (eV).

Y-axis: Intensity (arbitrary unit, a.u.).

FIGS. 5A and 5B show the XPS C1s spectra of NDs before exposure to microwaves (FIG. 5A) and after transformation to OLCs (FIG. 5B) according to Example 2.

X-axis: Bond energy (eV).

Y-axis: Intensity (a.u.).

FIG. 6 shows the zeta potential greater than 30 mV of the OLCs stabilized in water after exposure to UV according to Example 3.

X-axis: Apparent zeta potential (mV).

Y-axis: Total counts

### EXAMPLES

### Example 1

### Formation of OLCs Starting from NDs Without sp² Carbon at the Surface

Step 1: Hydrogenation by microwave (MW) plasma (300 W, 14-15 mbar, 15 min).

This treatment makes it possible to optimize the surface chemistry of the NDs to increase absorption of MWs. The detonation NDs are placed in a quartz tube under hydrogen and exposure to MWs induces formation of a hydrogen plasma. This method is described in the reference Girard et al., Diamond and related materials, 2010, 19, 1117-1123. It should be pointed out that the waveguide is cooled with water and the tube is cooled with compressed air. This tube is connected to a device for primary pumping and supply of high-purity hydrogen N9.0 and gaseous argon. First, a series of purges is carried out by primary pumping in the tube (pressure<0.1 mbar) and pressurizing with high-purity hydrogen, then high-purity hydrogen is injected until a pressure stabilized at 12 mbar is reached. This pressure is either maintained throughout the hydrogenation process by isolating the tube (static mode), or maintained by the combination of a continuous stream of hydrogen and a pressure regulating valve at a set value (dynamic mode). The geometry of the microwaves in the waveguide is adapted in order to obtain a maximum power absorbed by the plasma and a reflected power of zero at the level of the generator. The tube is regularly turned and moved manually to ensure that the majority of the NDs are exposed to the plasma. It is important to carry out a purge after 5 min of treatment in order to evacuate oxidized species desorbed from the surface of the NDs. After stopping the microwaves, the tube is pumped to low vacuum, then pure hydrogen is reintroduced in order to initiate formation of a plasma again. This intermediate purge is not used in the case of hydrogenation under dynamic flow. At the end of the treatment, the tube is cooled under hydrogen until it is at ambient temperature, then the residual gas is pumped. The tube is returned to ambient pressure by introducing argon, and then the NDs can be recovered.

Step 2: Pumping the Tube Under Low Vacuum (10⁻³ mbar) and MW Exposure of the Hydrogenated NDs (300 W, 30 Seconds).

The NDs hydrogenated by the method described in step 1 can be graphitized after hydrogenation, in situ, simply by exposing to microwaves again under low vacuum. In fact, the inventors observed that the hydrogenated NDs have the capacity to absorb microwaves under vacuum.

In order to observe this phenomenon, a pressure less than or equal to 10⁻³ mbar is required in the tube. In fact, a proportion of residual gas causes absorption of the microwaves, thus preventing the heating that is necessary for formation of OLCs.

By adapting the geometry of the microwave cavity, focusing of the MWs on the NDs is adjusted with the control piston in order to minimize the contribution reflected. Very rapid increase of the temperature of the NDs is reflected in scintillation of the nanoparticles. This observation of scintillation makes it possible to validate the experimental conditions required for formation of OLCs. Under these conditions, the microwave power is only absorbed by the NDs and is converted to heat. Exposure greater than or equal to 30 seconds leads to formation of nanoparticles that are entirely graphitic, the diamond core having disappeared completely.

### Example 2

### Formation of OLCs Starting from Detonation Nanodiamonds Having sp² carbon at the Surface

If sp² carbon is present at the surface of the nanodiamonds, hydrogenation is not necessary and direct exposure to microwaves allows graphitization. The experimental conditions allowing generation of graphitization of the surface of nanodiamonds have been detailed in the reference Petit et al., Phys Rev B, 2011, 84, 233407.

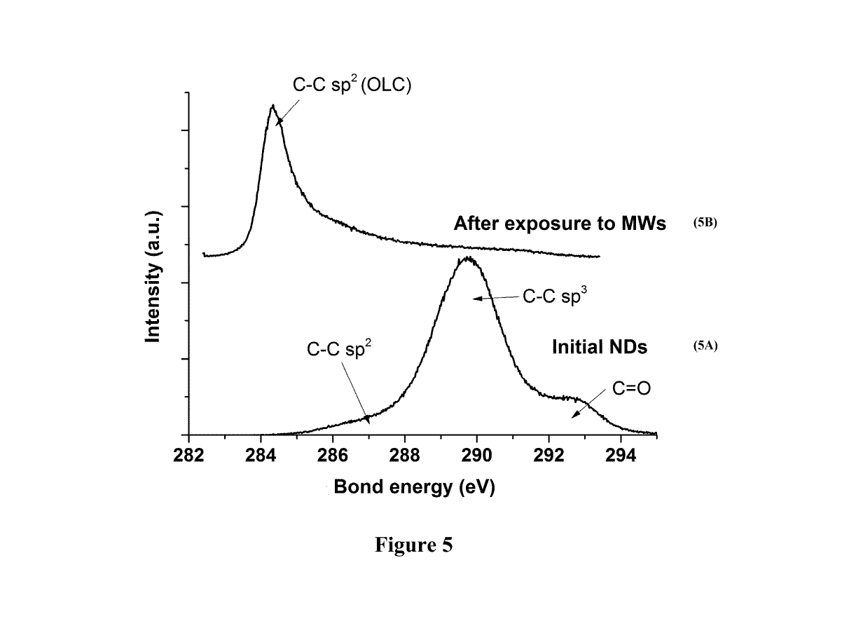

After 30 min of exposure to MWs (300 watts), NDs initially containing some graphitic structures (sp² C—C, FIG. 5A) at the surface were transformed to OLCs (FIG. 5B).

After treatment, an XPS spectrum very close to highly oriented graphite (highly oriented pyrolytic graphite, HOPG) can be seen, showing that the OLCs have very good crystalline quality (FIG. 5B).

### Example 3

### Stabilization of the OLCs in Water by UV Exposure Under Air

In order to be able to deposit these OLCs on large areas, for example for making supercapacitors, it is advantageous to obtain OLCs in the form of a stable suspension. These OLCs are initially hydrophobic but an oxidation treatment makes it possible to stabilize them in water. Use of a UV treatment is particularly interesting as it is possible to make the OLCs hydrophilic, without significantly altering their crystalline quality.

Thus, OLCs synthesized by MW exposure after hydrogenation (Example 1) were exposed to a UV lamp (172 nm, Heraeus excimer lamp) for 2 h under air. This exposure takes place in a confined enclosure the pressure of which can be regulated between atmospheric pressure and low vacuum. An atmosphere of pure oxygen can advantageously be used to increase the rate of oxidation. The optimum conditions correspond to 200 mbar. The distance between the NDs placed in a crucible and the UV lamp is less than 5 cm.

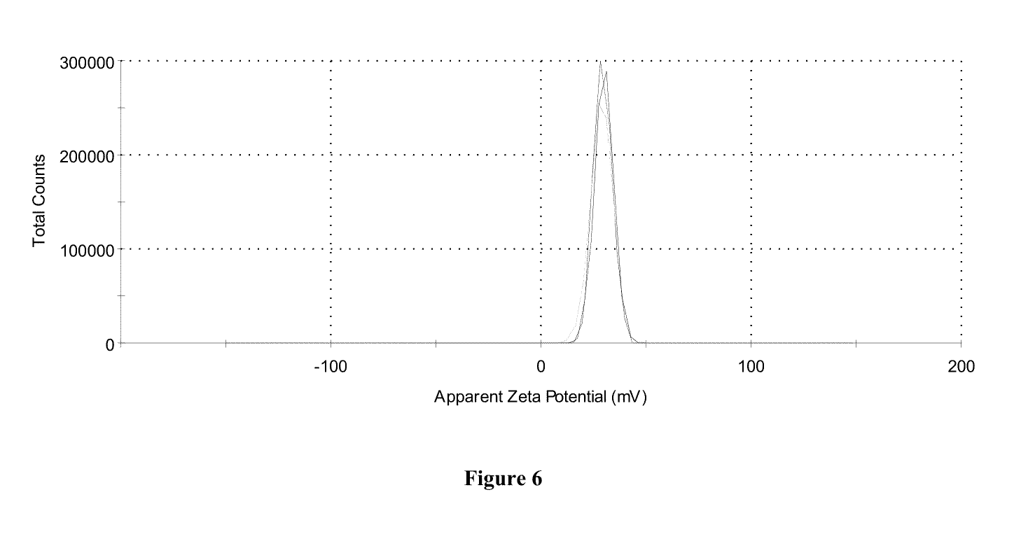

Then the OLCs were dispersed in water by sonication for 2 h and characterized by dynamic light scattering. They have a positive zeta potential in water greater than 30 mV (FIG. 6), which implies good colloidal stability.

1. Method for preparing onion-like carbons, comprising a step of exposing spherical nanodiamonds having a size of the crystalline core comprised between approximately 2 nm and approximately 10 nm, as measured by X-ray diffraction, to microwaves for a sufficient time t to lead to an increase in heat at the surface of the nanodiamonds such as to induce complete graphitization of the crystalline core, under low vacuum at a pressure less than or equal to approximately 10⁻³ mbar,
and in particular wherein said nanodiamonds have an overall size comprised between approximately 2 nm and approximately 15 nm, in particular from approximately 4 nm to approximately 10 nm.

2. Method according to claim 1, wherein:
prior to exposure to microwaves, said nanodiamonds have sp²-hybridized carbon atoms at their surface, or are substantially devoid of sp²-hybridized carbon atoms at their surface and are subjected to partial surface graphitization, in particular by annealing under high vacuum, prior to exposure to microwaves, in order to obtain nanodiamonds that are partially graphitized at the surface, or
prior to exposure to microwaves, said nanodiamonds have carbon-hydrogen bonds at their surface, or are substantially devoid of carbon-hydrogen bonds at their surface and have heteroelements such as oxygen, nitrogen or fluorine, and in particular more than 2 at. % of oxygen at said surface, and are subjected to partial surface hydrogenation, in order to obtain nanodiamonds that are partially hydrogenated at the surface.

3. Method according to claim 1, wherein the low vacuum in the enclosure in which the nanodiamonds are exposed to the microwaves corresponds to a pressure comprised between approximately 10⁻⁴ mbar to 10⁻³ mbar, in particular equal to approximately 10⁻³ mbar.

4. Method according to claim 1, wherein said nanodiamonds:
are partially graphitized at the surface, or
are substantially devoid of sp²-hybridized carbon atoms at their surface and are subjected, prior to exposure to microwaves, to partial surface graphitization.

5. Method according to claim 1, comprising the following steps:
a. Under low vacuum, pumping an enclosure, in particular constituted by a quartz tube, into which nanodiamonds partially graphitized at the surface have been introduced, in order to obtain a pressure comprised between approximately 10⁻⁴ mbar and 10⁻³ mbar, in particular a pressure of approximately 10⁻³ mbar;
b. Exposing said enclosure containing the nanodiamonds, partially graphitized at the surface, under low vacuum obtained in the preceding step, to microwaves the power of which is comprised between approximately 50 watts and approximately 2000 watts, the power being in particular approximately 300 watts, for a time t comprised between approximately 1 second and approximately 1 hour, in particular approximately 30 minutes, in order to induce complete graphitization of the crystalline core of the nanodiamonds and obtain onion-like carbons.

6. Method according to claim 5, further comprising, before the step of pumping under low vacuum, a step of partial surface graphitization of nanodiamonds that are substantially devoid of sp²-hybridized carbon atoms at their surface,
said graphitization in particular being carried out by annealing under high vacuum,
in order to produce nanodiamonds that are partially graphitized at the surface.

7. Method according to claim 1, wherein said nanodiamonds, prior to exposure to microwaves:
have carbon-hydrogen bonds at their surface, or
are substantially devoid of carbon-hydrogen bonds at their surface and have heteroelements such as oxygen, nitrogen or fluorine, and in particular more than 2 at. % of oxygen at said surface, and are subjected to partial surface hydrogenation, in order to obtain nanodiamonds that are partially hydrogenated at the surface, or
are insufficiently hydrogenated at their surface and have heteroelements such as oxygen, nitrogen or fluorine, and in particular more than 2 at. % of oxygen at said surface, and are subjected to partial surface hydrogenation in order to obtain nanodiamonds that are partially hydrogenated at the surface.

8. Method according to claim 7, comprising the following steps:
a. Under low vacuum, pumping an enclosure, into which nanodiamonds partially hydrogenated at the surface have been introduced, in order to obtain a pressure comprised between approximately 10⁻⁴ mbar and 10⁻³ mbar, in particular a pressure of approximately 10⁻³ mbar;
b. Exposing said enclosure, containing the nanodiamonds partially hydrogenated at the surface, under low vacuum obtained in the preceding step, to microwaves the power of which is comprised between approximately 50 watts and approximately 2000 watts, the power being in particular approximately 300 watts, for a time t comprised between approximately 1 second and approximately 1 minute, in particular 30 seconds, in order to induce complete graphitization of the crystalline core of the nanodiamonds and obtain onion-like carbons.

9. Method according to claim 8, further comprising, before the step of pumping under low vacuum, a step of hydrogenation of nanodiamonds that are substantially devoid of carbon-hydrogen bonds at their surface and have heteroelements such as oxygen, nitrogen or fluorine, and in particular more than 2 at. % of oxygen at said surface, said hydrogenation in particular being carried out by microwave plasma, under a pressure of 14-15 mbar at a power from 50 W to approximately 2000 W, in particular 300 W, for 5 minutes to approximately 30 minutes, in particular 15 minutes,
in order to produce nanodiamonds that are partially hydrogenated at the surface.

10. Method according to claim 1, wherein the power absorbed by said nanodiamonds is substantially equal to 100% and the power reflected is substantially equal to 0%,
and in particular in which increasing the temperature in said enclosure under low vacuum containing partially graphitized nanodiamonds, or partially hydrogenated nanodiamonds, during exposure to microwaves for said time t, causes scintillation or emission of white light from said partially graphitized nanodiamonds, or from said partially hydrogenated nanodiamonds.

11. Method according to claim 1, wherein said onion-like carbons, obtained after exposure to microwaves, are exposed to UV, in particular in air and to a UV wavelength of approximately 172 nm, under an oxygen atmosphere in order to make the aforesaid onion-like carbons hydrophilic,
in particular in which the air pressure before UV exposure is adjusted to approximately 200 mbar,
and in particular in which the UV exposure time is comprised between 1 minute and 4 hours, in particular 2 hours.

12. Method according to claim 11, wherein exposure to microwaves and exposure to UV are carried out in the same enclosure, in particular constituted by a quartz tube,
and in particular in which hydrogenation, exposure to microwaves and exposure to UV are carried out in the same enclosure, in particular constituted by a quartz tube.

13. Product as obtained by the method according to claim 11.

14. Method according to claim 2, wherein said nanodiamonds:
are partially graphitized at the surface, or
are substantially devoid of sp²-hybridized carbon atoms at their surface and are subjected, prior to exposure to microwaves, to partial surface graphitization.
